(19) United States
(12) Patent Application Publication
(10) Pub. No.: US 2024/0264190 A1
(43) Pub. Date: Aug. 8, 2024

(54) AUTOMATIC ANALYZER AND METHOD FOR DETECTING ADHESION OF LIQUID DROPLET TO PROBE

(71) Applicant: CANON MEDICAL SYSTEMS CORPORATION, Otawara-shi (JP)

(72) Inventors: Takahiro SEMACHI, Sakura (JP); Isamu MATSUDA, Sakura (JP); Makoto OGASAWARA, Otawara (JP); Kiwamu KODAMA, Otawara (JP); Yuki SHIMODAIRA, Nasushiobara (JP); Yuya KOMORI, Nasushiobara (JP)

(73) Assignee: CANON MEDICAL SYSTEMS CORPORATION, Otawara-shi (JP)

(21) Appl. No.: 18/434,924

(22) Filed: Feb. 7, 2024

(30) Foreign Application Priority Data
Feb. 8, 2023 (JP) 2023-017741

(51) Int. Cl. G01N 35/10; G01N 35/02

(52) U.S. Cl. CPC G01N 35/1004; G01N 35/025; G01N 35/1002

(57) ABSTRACT

An automatic analyzer includes a probe, a detector, and a controller. The probe sucks and discharges a sample and/or a reagent. The detector detects that the probe is in contact with a liquid. The controller detects that a liquid droplet adheres to the probe based on a detection result of the detector.

### CROSS REFERENCE TO RELATED APPLICATIONS

This application is based upon and claims the benefit of priority from the prior Japanese Patent Application No. 2023-017741, filed on Feb. 8, 2023, the entire contents of which are incorporated herein by reference.

### FIELD

One or more embodiments disclosed herein and the drawings relate to an automatic analyzer and a method for detecting adhesion of a liquid droplet to a probe.

### BACKGROUND

Automatic analyzers for performing qualitative or quantitative analyses of samples such as blood or urine are known. In an automatic analyzer, a probe is inserted into a reagent container or a sample container to suck a fluid such as a reagent or a sample in the container and to dispense the fluid to a reaction container held by a reaction disk. Generally, every time sucking and discharging of a fluid is performed, the probe is cleaned by a cleaner.

When the sucking and the discharging of the fluid such as a reagent or a sample is performed, sometimes part of the fluid may form a liquid droplet and adheres to an outer surface of the probe when the probe is removed from the surface of the fluid. The liquid droplet may be caused when the outer surface of the probe deteriorates or becomes dirty due to long-term use, for example. If there is a leakage in a flow passage of the probe, the fluid may drip from the tip of the probe when an arm holding the probe rotates. Such a dipping may cause a liquid droplet to be formed on the outer surface or the probe. If the fluid is discharged into the reaction container with the liquid droplet still adhering to the outer surface of the probe, the liquid droplet may drip into the reaction container. As a result, the amount of the reagent or the sample discharged into the reaction container may be increased.

A liquid droplet may also be caused when part of a cleaning fluid adheres to the outer surface of the probe after the probe is cleaned by the cleaner. Water such as pure water may be used as the cleaning fluid. If the reagent or the sample is sucked with the liquid droplet of the cleaning fluid adhering to the outer surface of the probe, the liquid droplet of the cleaning fluid may drip into the reagent container or the sample container. As a result, the reagent or the sample in the reagent container or the sample container may be thinned by the cleaning fluid such as water.

As described above, if the liquid droplet adhering to the outer surface of the probe drips into the reaction container, the reagent container, or the sample container, the concentration of the reagent or the sample may become greater or less than a predetermined range, which may impair the accuracy of analysis performed by the automatic analyzer.

### DETAILED DESCRIPTION

A problem to be solved by one or more embodiments disclosed herein or the accompanying drawings is to detect that a liquid droplet adheres to an outer surface of a probe in an automatic analyzer. The problem, however, is not the only problem. More than one problem may also be raised in association with an effect provided by each feature in the one or more embodiments described below.

### BRIEF DESCRIPTION OF THE DRAWINGS

FIG. 1 is a block diagram showing an example of a configuration of an automatic analyzer.

FIG. 2 is a diagram showing an example of functions of an analysis controller of the automatic analyzer.

FIG. 3 is a diagram showing an example of a configuration of an analysis executor of the automatic analyzer.

FIG. 4 is a flow chart showing an example of a method for detecting adhesion of a liquid droplet of a reagent or a sample or the like to a probe.

FIG. 5 is a diagram for explaining the step of detecting the adhesion of the liquid droplet to the probe.

FIG. 6 is a diagram for explaining the step of detecting the adhesion of the liquid droplet to the probe.

FIG. 7 is a diagram for explaining the step of detecting the adhesion of the liquid droplet to the probe.

FIG. 8 illustrates an example of a detection result of a detector when no liquid droplet adheres to an outer surface of the probe.

FIG. 9 illustrates an example of a detection result of the detector when the liquid droplet adheres to the outer surface of the probe.

FIG. 10 is a flow chart showing an example of a method for detecting adhesion of a liquid droplet of a cleaning fluid to a probe.

FIG. 11 is a diagram for explaining the step of detecting the adhesion of the liquid droplet to the probe.

### DETAILED DESCRIPTION

Embodiments will now be described with reference to the accompanying drawings. The scaling and the ratio between dimensions of an element may be different from those of the actual element in each drawing, for the easy understanding and the convenience of illustration.

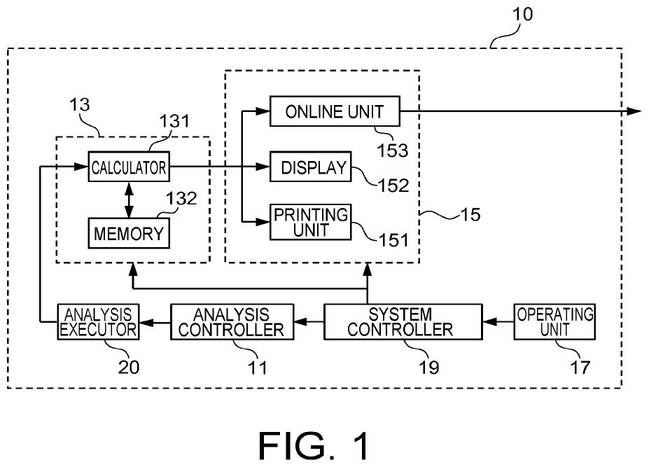

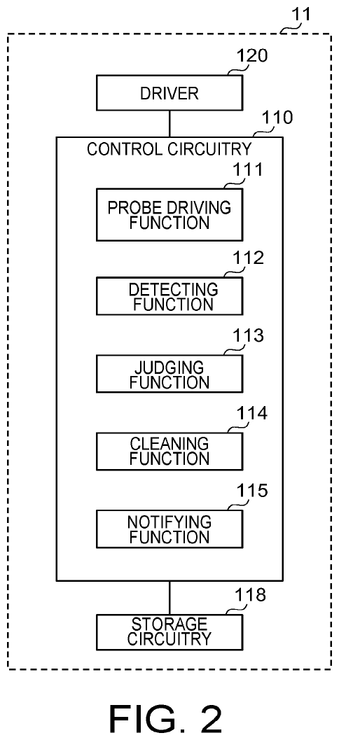

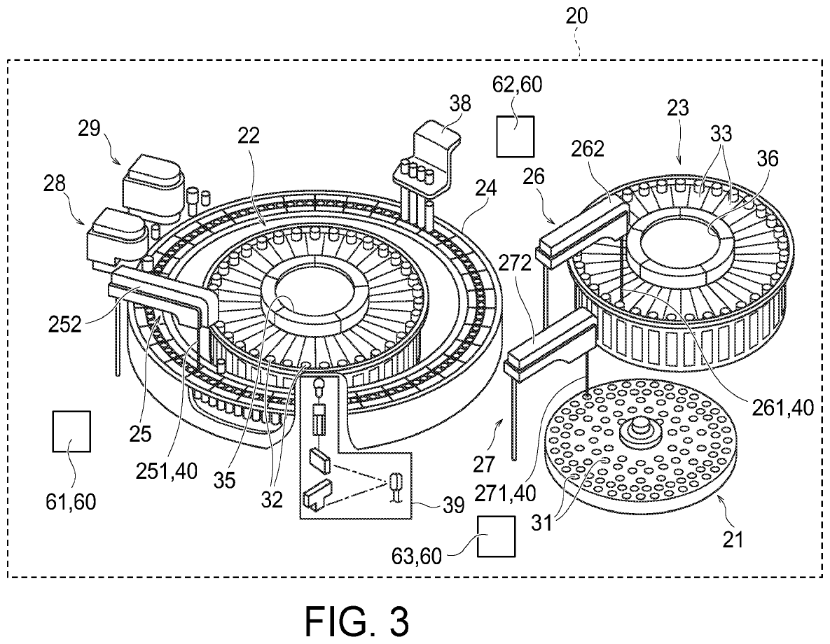

FIG. 1 is a block diagram showing an example of a configuration of an automatic analyzer 10. FIG. 2 is a diagram showing an example of functions of an analysis controller 11 of the automatic analyzer 10. FIG. 3 is a diagram showing an example of a configuration of an analysis executor 20 of the automatic analyzer 10.

The automatic analyzer 10 includes the analysis executor 20, the analysis controller 11, an analysis data processor 13, an output unit 15, an operating unit 17, and a system controller 19. The analysis executor 20 measures and analyzes a sample to be tested and a calibrator. The analysis controller 11 controls the analysis executor 20. The analysis data processor 13 processes an analysis signal outputted from the analysis executor 20 to calculate analysis data. The output unit 15 outputs the analysis data sent from the analysis data processor 13. The operating unit 17 receives inputs of analysis conditions and command signals. The system controller 19 controls the above-described components.

The analysis data processor 13 includes a calculator 131 that produces a calibration table from such signals as a calibration signal and an analysis signal outputted from the analysis executor 20 and calculates analysis data, and a memory 132 that stores the calibration table produced by the calculator 131 and the analysis data calculated by the calculator 131.

The calculator 131 produces a calibration table of each item based on a calibration signal relating to each item outputted from the analysis executor 20, and outputs the calibration table to the output unit 15 and also stores the calibration table in the memory 132. Furthermore, the calculator 131 reads out a calibration table from the memory 132, the calibration table corresponding to an item of the analysis signal outputted from the analysis executor 20, and calculates analysis data using the calibration table and outputs the analysis data to the output unit 15 and also stores the analysis data in the memory 132.

The memory 132 includes a hard disk, for example, and stores the calibration table and the analysis data for each sample to be tested outputted from the calculator 131.

The output unit 15 includes a printing unit 151 that prints and outputs the calibration table and the analysis data outputted from the analysis data processor 13, a display 152 that displays and outputs the calibration table and the analysis data, and an online unit 153 that outputs the analysis data to an external system such as an information system. The printing unit 151 includes a printer, and prints the calibration table and the analysis data outputted from the analysis data processor 13 on a sheet of printing paper based on a predetermined format. The display 152 includes a monitor such as a cathode ray tube (CRT), a liquid crystal display monitor, or an organic EL display monitor, and displays the calibration table and the analysis data outputted from the analysis data processor 13, and also displays a window used for the setting of the analysis conditions as instructed by the system controller 19.

The operating unit 17 includes an input device such as a keyboard, a mouse device, buttons, or a touch panel. As a result of an input, analysis conditions may be set, information of an object to be tested such as the ID and the name of the object to be tested may be inputted, measurement items for each sample to be tested of the object to be tested may be selected, and various operations such as a calibration of each item and an analysis of each sample to be tested may be performed.

The system controller 19 includes a CPU and storage circuity. After storing information such as a command signal of an operator supplied from the operating unit 17, analysis conditions, information of the object to be tested, and measurement items of each sample to be tested, the system controller 19 performs the control of the entire system such as the control of the respective components of the analysis executor 20 to operate in a predetermined cycle of a predetermined sequence, and the control relating to the generation of a calibration table and the calculation and output of the analysis data.

The analysis executor 20 analyzes samples. In particular, the analysis executor 20 generates blank data using blank measurement, reference data using reference measurement for measuring a mixed solution including a reference sample for each test item and a reagent used in the analysis for each test item, and test data using measurement of a mixed solution including a sample to be tested and the reagent. The analysis executor 20 includes a sample disk 21, a reagent carousel 22, a reagent carousel 23, a reaction disk 24, a first reagent dispenser 25, a second reagent dispenser 26, a sample dispenser 27, a first agitation mechanism 28, and a second agitation mechanism 29.

The sample disk 21 includes a plurality of sample containers 31, each of which contains a sample such as a reference sample or a sample to be tested, for example blood serum. The sample containers 31 are mounted on a sample rack, for example, and stored in the sample disk 21. One sample rack may have one or more sample containers 31.

The reagent carousel 22 includes a reagent rack 35 that stores a plurality of reagent containers 32 in a rotatable manner. The reagent rack 35 stores and cools a first reagent contained in the reagent containers 32. The first reagent in the reagent containers 32 are of a one-reagent system or two-reagent system, for example, and react with a component of a test item included in the sample such as a reference sample or a sample to be tested. The reagent carousel 23 includes a reagent rack 36 that stores a plurality of reagent containers 33 in a rotatable manner. The reagent rack 36 stores and cools a second reagent contained in the reagent containers 33. Each reagent container 33 thus contains the second reagent that is used with the first reagent. The reagent rack 35 may store both the reagent containers 32 containing the first reagent and the reagent containers 33 containing the second reagent.

The reaction disk (transporter) 24 has a plurality of fixing tools that are detachably attached on the circumference of the reaction disk 24. The fixing tools hold a plurality of reaction containers at predetermined intervals on the circumference of the reaction disk 24. Thus, the reaction disk 24 includes the fixing tools for fixing the reaction containers, and holds the reaction containers in a movable manner.

The first reagent dispenser 25 includes a first reagent dispensing probe 251 (probe 40), a first arm 252, and a first cleaning mechanism 61 (cleaner 60). The first reagent dispensing probe 251 is used for a dispensing operation including a suction of the first reagent in one of the reagent containers 32 stored in the reagent rack 35 and a discharge of the first reagent into the reaction containers to which the sample is discharged. The first arm 252 holds the first reagent dispensing probe 251 in a rotatable and vertically movable manner. The first cleaning mechanism 61 is used for cleaning the first reagent dispensing probe 251 every time the dispensing from the first reagent dispensing probe 251 is finished for one of the reagents.

The second reagent dispenser 26 includes a second reagent dispensing probe 261 (probe 40), a second arm 262, and a second cleaning mechanism 62 (cleaner 60). The second reagent dispensing probe 261 is used for a dispensing operation including a suction of the second reagent in one of the reagent containers 33 stored in the reagent rack 36, and a discharge of the second reagent into the reaction containers to which the first reagent is discharged. The second arm 262 holds the second reagent dispensing probe 261 in a rotatable and vertically movable manner. The second cleaning mechanism 62 is used for cleaning the second reagent dispensing probe 261 every time the dispensing of one of the reagents from the second reagent dispensing probe 261 is finished.

The sample dispenser 27 includes a sample dispensing probe 271 (probe 40), a third arm 272, and a third cleaning mechanism 63 (cleaner 60). The sample dispensing probe 271 is used for a dispensing operation including a suction of the sample in one of the sample containers 31 stored in the sample disk 21, and a discharge of the sample into the reaction containers. The third arm 272 holds the sample dispensing probe 271 in a rotatable and vertically movable manner. The third cleaning mechanism 63 is used for cleaning the sample dispensing probe 271 every time the dispensing from the sample dispensing probe 271 is finished for one of the samples.

Herein, each of the first reagent dispensing probe 251, the second reagent dispensing probe 261 and the sample dispensing probe 271 may be called a probe 40. The probe 40 thus indicate the first reagent dispensing probe 251, the second reagent dispensing probe 261 and the sample dispensing probe 271. Furthermore, each of the first cleaning mechanism 61, the second cleaning mechanism 62, and the third cleaning mechanism 63 may be called a cleaning mechanism (cleaner) 60. The cleaning mechanism (cleaner) 60 thus indicates the first cleaning mechanism 61, the second cleaning mechanism 62, and the third cleaning mechanism 63.

The first agitation mechanism 28 includes an agitator, an arm, and a cleaning pool. The agitator agitates a mixed solution including the sample and the first reagent that have been dispensed to the reaction container. The arm holds the agitator in a rotatable and vertically movable manner. The cleaning pool is used for cleaning the agitator every time the agitation of the mixed solution is finished.

The second agitation mechanism 29 includes an agitator, an arm, and a cleaning pool. The agitator agitates a mixed solution including the sample, the first reagent, and the second reagent that have been dispensed to the reaction container. The arm holds the agitator in a rotatable and vertically movable manner. The cleaning pool is used for cleaning the agitator every time the agitation of the mixed solution is finished.

The automatic analyzer 10 further includes a reaction container cleaner 38 and a measuring unit 39. The measuring unit 39 measures light passing through the reaction container containing a fluid such as water or a mixed solution. The reaction container cleaner 38 performs a cleaning operation for cleaning and drying the inside of the reaction container for which the measuring unit 39 has finished the measurement of the mixed solution. The reaction container cleaner 38 also pours a blank fluid such as pure water to the cleaned reaction container for blank measurement.

The measuring unit 39 generates blank data by performing a blank measurement for detecting light passing through the reaction container to which the blank fluid has been dispensed. The measuring unit 39 also generates reference data by performing a reference measurement for detecting the light passing through the mixed solution including the reference sample and the reagent in the reaction container. The measuring unit 39 further generates test data by performing a test measurement on the light passing through the mixed solution including the sample to be tested and the reagents in the reaction container.

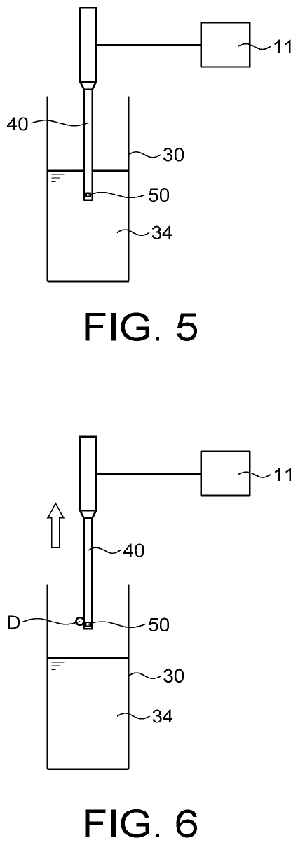

The automatic analyzer 10 according to one or more embodiments further includes a detector 50 (see FIG. 5). The detector 50 is disposed at a tip portion of the probe 40. For example, the detector 50 is an electrode configured to measure the potential of capacitance caused to the electrode. The detector 50 may detect that the probe 40 is in contact with the sample, the reagent, and/or the cleaning fluid by means of a change in potential of the capacitance. The detector 50 of one or more embodiments may also detect that the probe 40 is in contact with a liquid droplet D by means of a change in potential of the measured capacitance.

The analysis controller 11 controls the respective components of the analysis executor 20. For example, the analysis controller 11 sequentially assigns test items to the reaction containers that have been cleaned through a cleaning operation performed by the reaction container cleaner 38. The test items are selected for respective sample to be tested and inputted. The analysis controller 11 then causes the reaction container cleaner 38 to pour a blank fluid to the reaction containers to which the test items have been assigned. The amount of the blank fluid corresponds to the sum of the amount of the dispensed sample and the amount of the dispensed reagents. Subsequently, the analysis controller 11 causes the measuring unit 39 to perform a blank measurement of the reaction containers containing the blank fluid, thereby generating blank data.

The analysis controller 11 incudes control circuitry 110, storage circuity 118, and a driver 120. The control circuitry 110 controls the driver 120 to drive the analysis executor 20. The driver 120 includes, for example, a gear, a stepping motor, a belt conveyor system, and a lead screw. For example, the driver 120 separately rotates the sample disk 21, the reagent rack 35, and the reagent rack 36 to move the sample container 31, the reagent container 32, and the reagent container 33. The driver 120 rotatably drives the transporter (reaction disk) 24 to move the reaction containers. The driver 120 also separately drives the respective arms 252, 262, and 272 vertically and rotatably to move the probes 40 (251, 261, and 271).

The storage circuity 118 stores a program for at least performing a function of the control circuitry 110. In addition to such a program, the storage circuity 118 may store other programs and information such as data inputted via the operating unit 17 and data generated in the analysis executor 20. The storage circuity 118 includes a recording medium that can be read by a processor, such as a magnetic or optical recording medium, or a semiconductor memory. The storage circuity 118 is not necessarily formed of a single storage device. For example, the storage circuity 118 may include a plurality of storage devices.

The control circuitry 110 is a processor that functions as a main component of the automatic analyzer 10. The control circuitry 110 executes the program stored in the storage circuity 118 to perform one or more functions corresponding to the executed program. The control circuitry 110 may have a memory area for storing at least a portion of data stored in the storage circuity 118. As shown in FIG. 2, the control circuitry 110 executes the program stored in the storage circuity 118 to have, for example, a probe driving function 111, a detecting function 112, a judging function 113, a cleaning function 114, and a notifying function 115. In the embodiments described below, a single processor performs the probe driving function 111, the detecting function 112, the judging function 113, the cleaning function 114, and the notifying function 115, but this is not a limited feature. For example, a plurality of independent processors may be combined to form the control circuitry, and the respective functions may be realized by the respective processors executing programs.

In each embodiment described herein, the probe driving function 111 acts as a probe driver, the detecting function 112 acts as a detector, the judging function 113 acts as a judging unit, the cleaning function 114 of the control circuitry 110 acts as a cleaner, and the notifying function 115 acts as a notifying unit.

The probe driving function 111 controls the driver 120 to drive each probe 40. For example, when the probe driving function 111 is performed, the probe driving function 111 controls the driver 120 so that each probe 40 may be moved vertically (up and down direction) and/or horizontally.

The detecting function 112 controls the detector 50 to detect that the probe 40 is in contact with a liquid. For example, the liquid is a sample, a reagent, or a cleaning fluid. The detecting function 112 controls the detector 50 to detect that the probe 40 is in contact with a liquid based on, for example, a change in potential of the capacitance detected by the detector 50. In one or more embodiments, the detecting function 112 also controls the detector 50 that the probe 40 is in contact with a liquid droplet D.

The judging function 113 is a function for judging whether a liquid droplet adheres to the probe 40 based on a detection result obtained from the detector 50. Details of the judging method performed by the judging function 113 will be described later.

The cleaning function 114 is a function for cleaning the probe 40. In particular, the cleaning function 114 is a function for cleaning an outer surface 42 of the probe 40. Every time a dispensing of a sample or a reagent using the probe 40 is finished, the cleaning function 114 causes the probe 40 to be cleaned. In one or more embodiments, if a liquid droplet D (of a sample or a reagent, for example) adheres to the outer surface 42 of the probe 40 after the probe 40 sucks the sample or the reagent and moves, the probe 40 may be cleaned by the cleaning function 114. Furthermore, if a liquid droplet D (of a cleaning fluid, for example) adheres to the outer surface 42 after the probe 40 is cleaned and moved, the probe 40 may be cleaned by the cleaning function 114. When the cleaning function 114 is performed, a cleaning fluid is sprayed toward the outer surface 42 of the probe 40. As a result, the sample, the reagent, the cleaning fluid, or the like adhering to the outer surface 42 is washed out. For example, the cleaning fluid is water such as pure water. The probe 40 may be cleaned after a plurality of dispensing operations. The probe 40 may not be cleaned during the dispensing of one sample and continue sucking and dispensing operations when calibration or measurement of a control sample is performed. In other words, the probe 40 may be cleaned after a plurality of dispensing operations performed for one sample.

The notifying function 115 is a function for providing a notification to the operator (user). For example, when the adhesion of a liquid droplet D to the probe 40 is detected, the notifying function 115 may control the output unit 15 to provide a notification to the operator. The notifying function 115 may also control the output unit 15 so as to notify the operator of the cancellation of the sucking operation for sucking a sample and/or a reagent by means of the probe 40 or the cleaning operation for cleaning the probe 40 when the sucking or the cleaning is cancelled upon the detection of the adhesion of a liquid droplet D to the probe 40. Furthermore, the notifying function 115 may control the output unit 15 to send a notification to the operator when the aforementioned cancellation of the operation is added to the information in the memory 132.

For example, the analysis executor 20 of the automatic analyzer 10 according to one or more embodiments performs the steps of sample dispensing, first reagent dispensing, and second reagent dispensing in this order.

In the step of sample dispensing, first, the sample dispensing probe 271 is lowered into the sample container 31 held in the sample disk 21 to suck a predetermined amount of sample (fluid) into the sample dispensing probe 271. The sample dispensing probe 271 is then moved upward. Thereafter, the third arm 272 is pivoted so that the sample dispensing probe 271 is moved above the reaction container held by the reaction disk 24. Subsequently, the sample in the sample dispensing probe 271 is discharged into the reaction container. Thereafter, the third cleaning mechanism 63 cleans the sample dispensing probe 271.

In the step of first reagent dispensing, first, the first reagent dispensing probe 251 is lowered into the reagent container 32 held in the reagent rack 35 to suck a predetermined amount of first reagent into the first reagent dispensing probe 251. The first reagent dispensing probe 251 is then moved upward. Thereafter, the first arm 252 is pivoted so that the first reagent dispensing probe 251 is moved above the reaction container. Subsequently, the first reagent in the first reagent dispensing probe 251 is discharged into the reaction container. Thereafter, the first cleaning mechanism 61 cleans the first reagent dispensing probe 251.

In the step of second reagent dispensing, first, the second reagent dispensing probe 261 is lowered into the reagent container 33 held in the reagent rack 36 to suck a predetermined amount of second reagent into the second reagent dispensing probe 261. The second reagent dispensing probe 261 is then moved upward. Thereafter, the second arm 262 is pivoted so that the second reagent dispensing probe 261 is moved above the reaction container. Subsequently, the second reagent in the second reagent dispensing probe 261 is discharged into the reaction container. Thereafter, the second cleaning mechanism 62 cleans the second reagent dispensing probe 261.

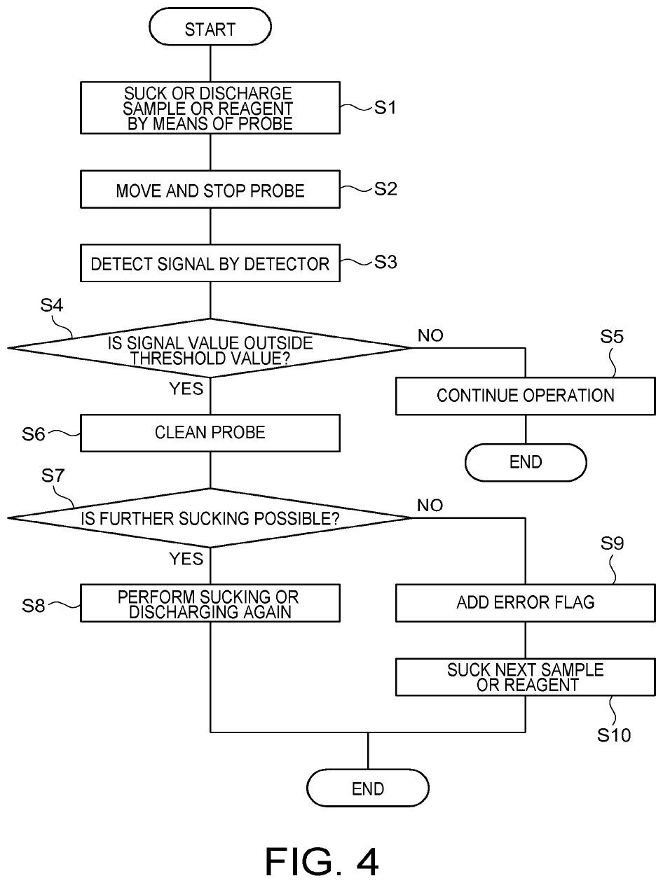

Examples of specific operations of the probe 40, the detector 50, and the controller 11 in the step of sample dispensing, the step of first reagent dispensing, and the step of second reagent dispensing will be described below with reference to FIGS. 4 to 7. FIG. 4 is a flow chart showing an example of a method for detecting adhesion of a liquid droplet D of the reagent or the sample or the like to the probe 40. FIGS. 5 to 7 are diagrams for explaining the step of detecting adhesion of the liquid droplet D of the reagent or the sample or the like to the probe 40.

In the step of sample dispensing, the step of first reagent dispensing, and the step of second reagent dispensing in one or more embodiments, the method of detecting the adhesion of the liquid droplet D to the probe 40 is the same. Therefore, the method of detecting the adhesion of the liquid droplet D to the probe 40 is described collectively for the step of sample dispensing, the step of first reagent dispensing and the step of second reagent dispensing. In the descriptions below, the sample container 31, the reagent container 32, and the reagent container 33 will be collectively called “container 30.” The sample, the first reagent, and the second reagent will be collectively called “fluid 34.” Therefore, in the step of sample dispensing, the container 30 indicates the sample container 31, and the fluid 34 indicates the sample. In the step of first reagent dispensing, the container 30 indicates the reagent container 32 and the fluid 34 indicates the first reagent. In the step of second reagent dispensing, the container 30 indicates the reagent container 33 and the fluid 34 indicates the second reagent.

First, the probe 40 is lowered until the tip (lower end) of the probe 40 is inserted into the container 30 as shown in FIG. 5. The lowering of the probe 40 is controlled and performed by the probe driving function 111 of the control circuitry 110. Thereafter, the sucking or discharging of the fluid 34 is performed by means of the probe 40 (step S1). The sucking and the discharging of the fluid 34 are controlled and performed by the probe driving function 111 of the control circuitry 110.

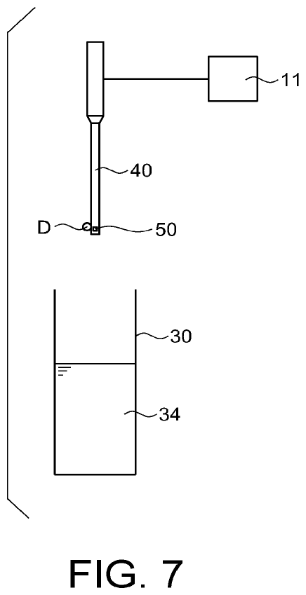

Next, as shown in FIGS. 6 and 7, the probe 40 is moved and stopped (step S2). In particular, the probe 40 is moved up and stopped in step S2. The movement of the probe 40 is controlled and performed by the probe driving function 111 of the control circuitry 110. FIG. 7 shows the state where the probe 40 is stopped. At this time, a portion of the fluid 34, a liquid droplet D, may adhere to the outer surface 42 of the probe 40. FIGS. 6 and 7 show an example in which the liquid droplet D adheres to the outer surface 42 of the probe 40. In one or more embodiments, whether the liquid droplet D adheres to the probe 40 is detected by means of the detector.

In one or more embodiments, the detector 50 always measures the potential of capacitance. In this case, whether the probe 40 is in contact with the liquid may always be detected. The measurement of the potential by the detector 50 is not limited to this example, but may be performed only within a predetermined period of time. After the detection by the detector 50 in step S2 that the probe 40 no longer in contact with the surface of the fluid 34, the detector 50 measures the potential to determine whether the liquid droplet D adheres to the probe 40 (step S3). The measurement is controlled and performed by the detecting function 112 of the control circuitry 110. The measurement is performed for a predetermined period of time, which may start after the detector 50 detects that the probe 40 is removed from the surface of the fluid 34, and end after the probe 40 is stopped. The predetermined period of time may start after the probe 40 is stopped, and may be, for example, 0.1 seconds and more and 2 seconds or less. Furthermore, the length of the predetermined period of time may be 0.2 seconds and more and 1.5 seconds or less, or 0.3 seconds or more and 1 second or less, or 0.4 seconds or more and 0.8 seconds or less. Examples of the length may include just 0.5 seconds.

The controller 11 judges whether the liquid droplet D adheres to the probe 40 based on the detection result of the detector 50 (step S4). The judgment is controlled and performed by the judging function 113 of the control circuitry 110. If a potential signal measured by the detector 50 in the predetermined period of time becomes greater than a threshold value T in step S4, the controller 11 judges that the liquid droplet D adheres to the probe 40. On the contrary, if the potential signal measured by the detector 50 does not become greater than the threshold value T in the predetermined period of time, the controller 11 judges that no liquid droplet D adheres to the probe 40.

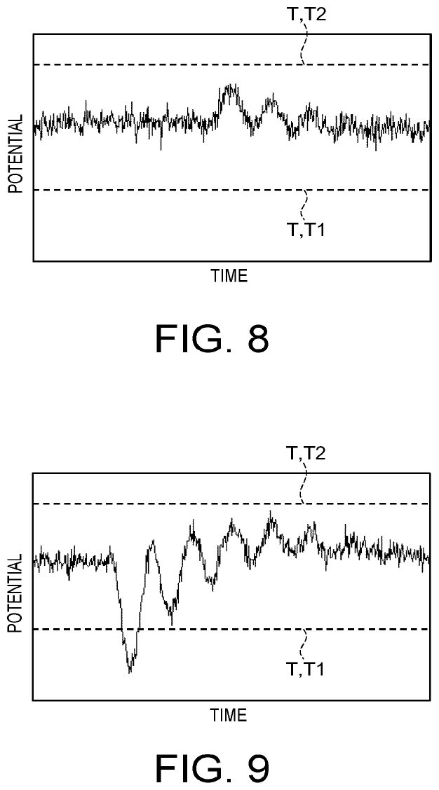

FIG. 8 illustrates an example of the detection result of the detector 50 when no liquid droplet D adheres to the outer surface 42 of the probe 40, and FIG. 9 illustrates an example of the detection result of the detector 50 when the liquid droplet D adheres to the outer surface 42 of the probe 40. In FIGS. 8 and 9, a lower limit value T1 and an upper limit value T2 are set as the threshold value T. The threshold value T is not limited to this example, and only a lower limit value T1 or only an upper limit value T2 may be set. The threshold value T (T1, T2) may be a potential value that is absolutely set, or a potential value that is set relative to a potential value measured by the detector 50 at a certain point in time.

In the examples shown in FIGS. 8 and 9, the left end of the graph is a start point of the predetermined period of time, and the right end is an end point. In the example shown in FIG. 8, the potential signal measured by the detector 50 in the predetermined period of time is within the range of the threshold value T (T1, T2). In this case, the controller 11 judges that no liquid droplet D adheres to the probe 40. In the example shown in FIG. 9, the potential signal measured by the detector 50 in the predetermined period of time becomes less than the threshold value T (less than the lower limit value T1). In this case, the controller 11 judges that the liquid droplet D adheres to the probe 40. The state that the potential signal measured by the detector 50 in the predetermined period of time is not within the range of the threshold value T (T1, T2) means that there is a time when the potential signal changes from a value that is greater than the lower limit value T1 to a value that is less than the lower limit value T1, or that the potential signal changes from a value that is less than the upper limit value T2 to a value that is greater than the upper limit value T2.

If the controller 11 judges that no liquid droplet D adheres to the probe 40 in step S4 (“NO” in step S4), the operation continues as usual (step S5). On the other hand, if the controller 11 judges that the liquid droplet D adheres to the probe 40 in step S4 (“YES” in step S4), the probe 40 is moved to the cleaner 60 (first cleaning mechanism 61, second cleaning mechanism 62, third cleaning mechanism 63) to clean the probe 40 by the cleaner 60 (step S6). The cleaning of the probe 40 is controlled and performed by the cleaning function 114 of the control circuitry 110.

If the controller 11 judges that the liquid droplet D adheres to the probe 40 in step S4, the controller 11 may send a notification to the operator. The notification is controlled and performed by the notifying function 115 of the control circuitry 110. The notification to the operator may be sent in the form of a print output from the printing unit 151, a display on the display 152, an audio output from a speaker, or the like. The notification to the operator may also be sent to an information terminal used by the operator via the online unit 153. The information terminal may be a personal computer, a mobile phone, a smartphone, a tablet terminal, or the like.

When the cleaning of the probe 40 is finished, the controller 11 judges whether a further sucking operation may be performed by the probe 40 (step S7). The judgement is controlled and performed by the judging function 113 of the control circuitry 110. For example, if the location of the container 30 where the sucking or the discharging was performed in step S1 has not been changed and a further sucking of the fluid 34 using the probe 40 may be possible, the judging function 113 of the control circuitry 110 may judge that a further sucking operation may be performed by the probe 40 in step S7. If the location of the container 30 where the sucking or the discharging is performed in step S1 has been changed, the judging function 113 of the control circuitry 110 may judge that a further sucking operation by the probe 40 is impossible. Whether a further sucking operation is possible may be determined in consideration of the time needed to perform a further sucking operation using the probe 40. A threshold value in time, during which a further sucking is determined to be possible, may be set in advance, and if the time needed for the probe 40 to be returned from the cleaning by the cleaner 60 is within the threshold value in time, the further sucking may be determined to be possible. If the time needed for the probe 40 to be returned from the cleaning by cleaner 60 is not within the threshold value in time, it is determined that further sucking is impossible.

If a further sucking operation by the probe 40 is determined to be possible in step S7 (“YES” in step S7), the fluid 34 is sucked again from the container 30 from which the sucking was performed or to which the discharging was performed in the step S1, and the fluid 34 sucked into the probe 40 is discharged to the reaction container (step S8).

The memory 132 in one or more embodiments stores information on the samples including, for example, an ID for specifying each sample and information associated with the ID. The information associated with the ID may include an analysis result for the sample specified by the ID.

If it is determined that a further sucking operation by the probe 40 is impossible in step S7 (“NO” in step S7), the controller 11 cancels the sucking or the discharging of the fluid 34 in the container 30, for which a sucking or a discharging operation has been performed in step S1. At this time, the controller 11 causes the memory 132 to additionally store information on the cancellation of the sucking or the discharging of the fluid 34 in the container 30, for which the sucking or the discharging has been performed in step S1, in association with the ID of the sample contained in the reaction container (step S9). The information to the effect that the shucking or the discharging of the fluid 34 is cancelled is called “error flag.” The addition of the error flag is controlled and performed by the judging function 113 of the control circuitry 110.

If the controller 11 causes the error flag to be added to the information stored in the memory 132 in step S9, the controller 11 may 11 may send a notification to the operator. The notification is controlled and performed by the notifying function 115 of the control circuitry 110. The notification to the operator may be sent in the form of a print output from the printing unit 151, a display on the display 152, an audio output from a speaker, or the like. The notification to the operator may also be sent to an information terminal used by the operator via the online unit 153. The information terminal may be a personal computer, a mobile phone, a smartphone, a tablet terminal, or the like.

Thereafter, an operation is performed on a next container 30. Specifically, sucking of the fluid 34 in the next container 30 using the probe 40 is performed (step S10). Step S10 may be step S1 for the next container 30.

When the cleaner 60 cleans the probe 40, a liquid droplet D of the cleaning fluid may adhere to the outer surface 42 of the probe 40. If sucking of a reagent or a sample is performed with the liquid droplet D of the cleaning fluid adhering to the outer surface 42, the liquid droplet D may drip into the sample container 31 or the reagent container 32 or 33. As a result, the sample or the reagent in the sample container 31 or the reagent container 32, 33 is thinned by the cleaning fluid.

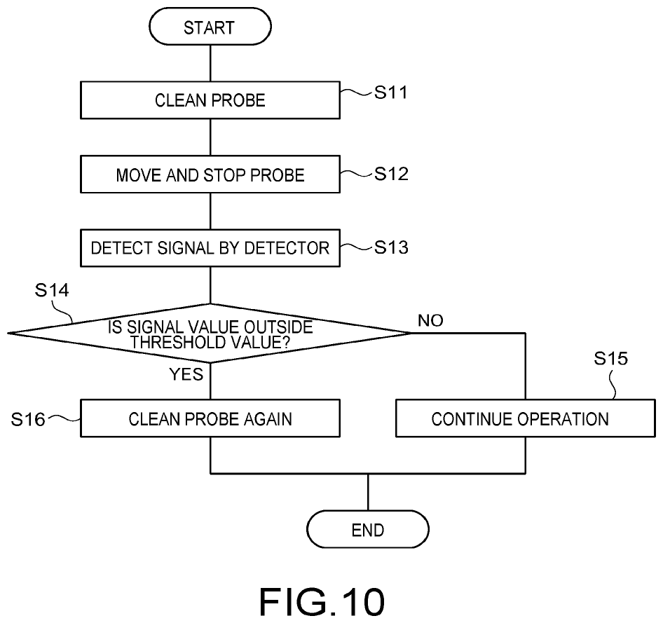

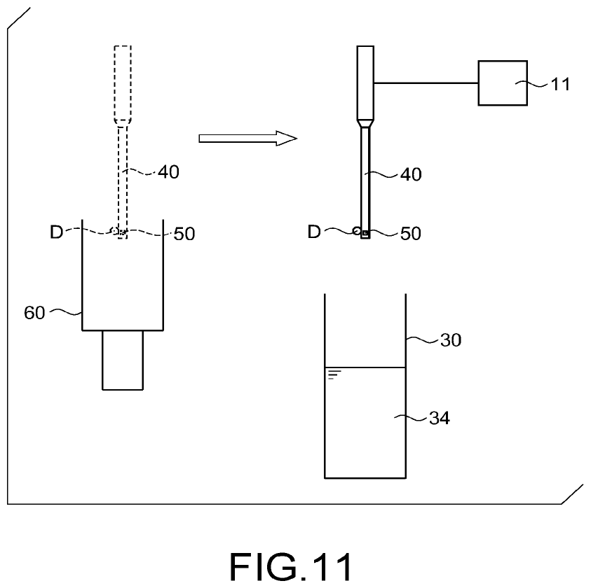

The automatic analyzer 10 according to one or more embodiments is capable of detecting whether a liquid droplet D of the cleaning fluid adheres to the probe 40 cleaned by the cleaner 60. An example of specific operations of the probe 40, the detector 50, and the controller 11 in the cleaning operation will be described below with reference to FIGS. 10 and FIG. 11. FIG. 10 is a flow chart showing an example of a method for detecting the adhesion of the liquid droplet D of the cleaning fluid to the probe 40. FIG. 11 is a diagram for explaining the step of detecting the adhesion of the liquid droplet D to the probe 40.

First, the cleaner 60 cleans the probe 40 (step S11). In step S11, the cleaner 60 sprays the cleaning fluid to the probe 40 to wash out the sample or the reagent adhering to the probe 40. Water such as pure water is used as the cleaning fluid. The cleaning of the probe 40 is controlled and performed by the cleaning function 114 of the control circuitry 110.

Next, the probe 40 is moved and stopped (step S12). In step S12, the probe 40 may be horizontally moved and stopped above the container 30. Alternatively, in step S12, the probe 40 may be moved upward and stopped. The movement of the probe 40 is controlled and performed by the probe driving function 111 of the control circuitry 110. FIG. 11 shows the state where the probe 40 is moved horizontally and stopped above the container 30. In FIG. 11, a liquid droplet D of the cleaning fluid adheres to the outer surface 42 of the probe 40. In one or more embodiments, the detector 50 is used for detecting whether a liquid droplet D of the cleaning fluid adheres to the probe 40.

After the detector 50 detects that the probe 40 is removed from the cleaning fluid sprayed from the cleaner 60 in step S12, the detector 50 measures the potential for detecting whether a liquid droplet D adheres to the probe 40 (step S13). The measurement is controlled and performed by the detecting function 112 of the control circuitry 110. The measurement is performed for a predetermined period of time, which may start when the detector 50 detects that the probe 40 is removed from the cleaning fluid being sprayed from the cleaner 60, and end when the probe 40 is stopped. The predetermined period of time may start after the probe 40 is stopped. The length of the predetermined period of time may be, for example, 0.1 seconds or more and 2 seconds or less, or 0.2 seconds or mere and 1.5 seconds or less, or 0.3 seconds or more and 1 second or less, or 0.4 seconds and more and 0.8 seconds or less. Examples of the length may include just 0.5 seconds.

The controller 11 judges whether a liquid droplet D adheres to the probe 40 based on a detection result of the detector 50 (step S14). The judgement is controlled and performed by the judging function 113 of the control circuitry 110. If a potential signal measured by the detector 50 in the predetermined time is not within the range of a threshold value T in step S14, the controller 11 judges that the liquid droplet D adheres to the probe 40. One the contrary, if the potential signal measured by the detector 50 is within the range of the threshold value T in the predetermined period of time, the controller 11 judges that no liquid droplet D adheres to the probe 40.

If the controller 11 judges that no liquid droplet D adheres to the probe 40 in step S14 (“NO” in step S14), the operation continues as usual (step S15). On the other hand, if the controller 11 judges that the liquid droplet D adheres to the probe 40 in step S14 (“YES” in step S14), the probe 40 is moved to the cleaner 60 to clean the probe 40 again by the cleaner 60 (step S16). The re-cleaning of the probe 40 is controlled and performed by the cleaning function 114 of the control circuitry 110.

If the controller 11 judges that the liquid droplet D adheres to the probe 40 in step S14, the controller 11 may send a notification to the operator. The notification is controlled and performed by the notifying function 115 of the control circuitry 110. The notification to the operator may be sent in the form of a print output from the printing unit 151, a display on the display 152, an audio output from a speaker, or the like. The notification to the operator may also be sent to an information terminal used by the operator via the online unit 153. The information terminal may be a personal computer, a mobile phone, a smartphone, a tablet terminal, or the like.

The detection of the adhesion of the liquid droplet D to the probe 40 described with reference to FIGS. 10 and 11 may be performed during the cleaning of the probe 40 in step S6 described with reference to FIG. 4.

If the controller 11 judges that the liquid droplet D adheres to the probe 40 in step S14, the controller 11 may cancel the cleaning operation by the cleaner 60. At this time, the controller 11 may cause the memory 132 to additionally store information (error flag) on the cancellation of the cleaning operation in association with the ID of the sample contained in the reaction container to which the fluid 34 is to be discharged from the container 30 for which the sucking or the discharging has been performed in step S1. The addition of the error flag is controlled and performed by the judging function 113 of the control circuitry 110.

[1] An automatic analyzer 10 according to one or more embodiments is:
an automatic analyzer including:
a probe 40 configured to perform sucking and discharging of a sample and/or a reagent;
a detector 50 configured to detect that the probe 40 is in contact with a liquid; and
a controller 11 configured to detect that a liquid droplet D adheres to the probe 40 based on a detection result of the detector 50.

An automatic analyzer 10 according to one or more embodiments is:

[2] the automatic analyzer according to [1], wherein the controller 11 judges that the liquid droplet D adheres to the probe 40 when a signal detected by the detector 50 is not within a range of a threshold value T.

An automatic analyzer 10 according to one or more embodiments is:

[3] the automatic analyzer 10according to [2],
wherein the threshold value T is a predetermined lower limit value,
wherein the controller 11 judges that the liquid droplet D adheres to the probe 40 when the signal detected by the detector 50 is less than the lower limit value T1.

An automatic analyzer 10 according to one or more embodiments is:

[4] the automatic analyzer 10 according to [2] or [3], the signal is detected by the detector 50 after a movement of the probe 40 is finished.

An automatic analyzer 10 according to one or more embodiments is:

[5] the automatic analyzer 10 according to any one of [1] to [4], wherein if it is detected that the liquid droplet D adheres to the probe 40 after the sucking of the sample and/or the reagent, or after cleaning of the probe 40, the controller 11 performs a cancellation of the sucking or a cancellation of the cleaning.

An automatic analyzer 10 according to one or more embodiments is:

[6] the automatic analyzer 10 according to [5], further including a memory 132 configured to store information on the sample,
wherein when performing the cancellation of the sucking or the cancellation of the cleaning, the controller 11 adds information relating to the cancellation to the information on the sample relating to the sucking that is cancelled or to the cleaning that is cancelled.

An automatic analyzer 10 according to one or more embodiments is:

[7] the automatic analyzer 10 according to [6], wherein if the controller 11 adds the information relating to the cancellation to the information on the sample relating to the sucking that is cancelled or to the cleaning that is cancelled, the controller 11 sends a notification to an operator.

An automatic analyzer 10 according to one or more embodiments is:

[8] an automatic analyzer 10 according to any one of [1] to [7], wherein when the controller 11 detects that the liquid droplet D adheres to the probe 40, the controller 11 causes the probe 40 to be cleaned.

An automatic analyzer 10 according to one or more embodiments is:

[9] the automatic analyzer 10according to [8], wherein after the probe 40 is cleaned, the controller 11 judges whether a further sucking operation is possible for the probe 40.

An automatic analyzer 10 according to one or more embodiments is:

[10] the automatic analyzer 10according to any one of [1] to [9], wherein the controller 11 sends a notification to an operator when detecting that the liquid droplet D adheres to the probe 40.

An automatic analyzer 10 according to one or more embodiments is:

[11] the automatic analyzer 10according to any one of [1] to [10], wherein the detector 50 is an electrode configured to measure a potential of capacitance.

An automatic analyzer 10 according to one or more embodiments is:

[12] the automatic analyzer 10any one of [1] to [11], wherein the detector 50 is disposed at a tip portion of the probe 40.

An automatic analyzer 10 according to one or more embodiments is:

[13] the automatic analyzer 10according to any one of [1] to [12], wherein the detector 50 is capable of detecting that the probe 40 is in contact with a fluid 34 contained in a container 30, and that the probe 40 is in contact with the liquid droplet D.

A method for detecting adhesion of a liquid droplet to a probe 40 according to one or more embodiments is:

[14] a method for detecting adhesion of a liquid droplet to a probe 40 in an automatic analyzer 10 including a probe 40 configured to perform sucking and discharging of a sample and/or a reagent, and a detector 50 configured to detect that the probe 40 is inContact with a liquid, the method comprising:
detecting that a liquid droplet D adheres to the probe 40 based on a detection result of the detector 50.

The term “processor” in the above descriptions means circuitry such as a central processing unit (CPU), a graphics processing unit (GPU), an application specific integrated circuit (ASIC), a programmable logic device like a simple programmable logic device (SPLD) or a complex programmable logic device (CPLD), and a field programmable gate array (FPGA). If the processor is a CPU, for example, the processor performs a function by reading a program stored in storage circuity. If the processor is an ASIC, the processor has the function realized as a logic circuit and directly included in the circuitry of the processor instead of being stored in the storage circuity. The processor of one or more embodiments is not limited to be a single circuit, but may be a combination of a plurality of independent circuits formed as a single processor to perform one or more processing functions. The components shown in FIG. 1 may be implemented to a single processor to perform processing functions.

While certain embodiments and their modifications have been described, these embodiments and modifications have been presented by way of example only, and are not intended to limit the scope of the inventions. Indeed, a variety of other forms such as omissions, substitutions, changes and combinations may be made in the embodiments and modifications without departing from the spirit of the inventions. Such embodiments and modifications are intended to be covered by the scope and spirit of the inventions as well as the claimed inventions and their equivalents.

1. An automatic analyzer comprising:
a probe configured to perform sucking and discharging of a sample and/or a reagent;
a detector configured to detect that the probe is in contact with a liquid; and
a controller configured to detect that a liquid droplet adheres to the probe based on a detection result of the detector.

2. The automatic analyzer according to claim 1, wherein the controller judges that the liquid droplet adheres to the probe when a signal detected by the detector is not within a range of a threshold value.

3. The automatic analyzer according to claim 2,
wherein the threshold value is a predetermined lower limit value,
wherein the controller judges that the liquid droplet adheres to the probe when the signal detected by the detector is less than the lower limit value.

4. The automatic analyzer according to claim 2, wherein the signal is detected by the detector after a movement of the probe is finished.

5. The automatic analyzer according to claim 1, wherein if it is detected that the liquid droplet adheres to the probe after the sucking of the sample and/or the reagent, or after cleaning of the probe, the controller performs a cancellation of the sucking or a cancellation of the cleaning.

6. The automatic analyzer according to claim 5, further comprising a memory configured to store information on the sample,
wherein when performing the cancellation of the sucking or the cancellation of the cleaning, the controller adds information relating to the cancellation to the information on the sample relating to the sucking that is cancelled or to the cleaning that is cancelled.

7. The automatic analyzer according to claim 6, wherein if the controller adds the information relating to the cancellation to the information on the sample relating to the sucking that is cancelled or to the cleaning that is cancelled, the controller sends a notification to an operator.

8. The automatic analyzer according to claim 1, wherein when the controller detects that the liquid droplet adheres to the probe, the controller causes the probe to be cleaned.

9. The automatic analyzer according to claim 8, wherein after the probe is cleaned, the controller judges whether a further sucking operation is possible for the probe.

10. The automatic analyzer according to claim 1, wherein the controller sends a notification to an operator when detecting that the liquid droplet adheres to the probe.

11. The automatic analyzer according to claim 1, wherein the detector is an electrode configured to measure a potential of capacitance.

12. The automatic analyzer according to claim 1, wherein the detector is disposed at a tip portion of the probe.

13. The automatic analyzer according to claim 1, wherein the detector is capable of detecting that the probe is in contact with a fluid contained in a container, and that the probe is in contact with the liquid droplet.

14. A method for detecting adhesion of a liquid droplet to a probe in an automatic analyzer including a probe configured to perform sucking and discharging of a sample and/or a reagent, and a detector configured to detect that the probe is in contact with a liquid, the method comprising:
detecting that a liquid droplet adheres to the probe based on a detection result of the detector.
